(19) United States
(12) Patent Application Publication
(10) Pub. No.: US 2002/0041333 A1
(43) Pub. Date: Apr. 11, 2002

(54) Solid state imaging camera with an imaging element having a two picture signal field output

(75) Inventors: Kenji Suzuki, Kawasaki-shi (JP); Kiyoshige Shibazaki, Tokyo (JP)

Correspondence Address: STAAS & HALSEY LLP, 700 11TH STREET, NW, SUITE 500, WASHINGTON, DC, 20001, US

(73) Assignee: Nikon Corporation, Tokyo (JP)

(21) Appl. No.: 10/011,706

(22) Filed: Dec. 11, 2001

Related U.S. Application Data
(63) Continuation of application No. 08/982,705, filed on Dec. 1, 1997, now abandoned.

(30) Foreign Application Priority Data
Nov. 29, 1996 (JP) 08-334617

(51) Int. Cl. H04N 5/335

(52) U.S. Cl. 348/311; 348/323

(57) ABSTRACT

A solid state imaging camera having an imaging element to image light from a subject using pixel groups. The pixel groups are arrayed two-dimensionally to obtain a pixel signal group by transmitting serially to a first horizontal transmission register, and from the first horizontal transmission register to a second horizontal transmission register. The first and second horizontal transmission registers each have a respective output terminal positioned in parallel relative to each other to output two fields of picture signals that are then added by an adding circuit. A signal processing unit outputs predetermined signal processing of the added picture signals. In addition, a second signal processing unit can be disposed which effects predetermined signal processing on the signals from one of the two picture output terminals of the imaging element.

### CROSS-REFERENCE TO RELATED APPLICATIONS

This application is a continuation of U.S. patent application Ser. No. 08/982,705, filed Dec. 1, 1997, now abandoned. This application is based upon and claims priority to Japanese patent application No. 08-334617, filed Nov. 29, 1996 and U.S. patent application Ser. No. 08/982,705, filed Dec. 1, 1997, the contents of which are incorporated herein by reference.

### BACKGROUND OF THE INVENTION

The present invention relates to solid state imaging cameras. More particularly, the present invention relates to solid state imaging cameras for simultaneously performing separated picture readout in two field times and readout of all the pixel data in one field time.

FIGS. 5A (prior art) and 5B (prior art) illustrate a first conventional solid state imaging element having a transmission operation which outputs a plurality of pixel image signals 102 by way of a corresponding plurality of photosensors FS1 and FS2. In FIG. 5A, a first pixel signal field 104 is formed from a horizontal row of pixel image signals 102. Likewise, in FIG. 5B, a second pixel signal field 105 is formed from a horizontal row of pixel image signals 102. Each pixel signal field 104 and 105 is simultaneously output until all image signals 102 have been output.

All imaged pixel signals from a conventional solid state imaging element are transmitted by fields, separated in time, from a single transmission output terminal (not shown). For example, in FIG. 5A, pixel signal field 104 imaged by photosensors FS1 correspond to a first field and are sequentially transmitted. Likewise, in FIG. 5B, pixel signal field 105 imaged by photosensors FS2 correspond to a second field and are sequentially transmitted. Since first pixel signal field 104 is transmitted in a first field time, and the second pixel signal field 105 is transmitted in a second field time, two fields are required in order to transmit all pixel signals 102.

FIGS. 4A (prior art) and 4B (prior art) illustrate a second conventional solid state imaging element having a transmission operation which reads out fields of imaged pixel signals 102 in one field time. Pixel image signals 102 are imaged by photosensors FS1 and FS2 and then added by transmission units within a charge coupled device (“CCD”). Imaged pixel image signals 102 are added to become pixel signals 103, which are then transmitted and output. The solid state imaging element illustrated in FIGS. 4A and 4B are similar to the solid state imaging elements illustrated in FIG. 5A (prior art) and FIG. 5B (prior art). Output from photosensors FS1 are grouped as a first field 104 and output from photosensors FS2 are grouped as a second field 105. As illustrated in FIG. 4A, in a first field time, the imaging element adds the pixel signals from photosensors FS1 corresponding to the first field 104 and pixel signals from photosensors FS2 corresponding to the second field 105 in a vertical transmission CCD 41. The added two-line pixel signals 103 are transmitted horizontally and output by a horizontal transmission CCD (not shown). Similarly, in a second field time, illustrated in FIG. 4B, the imaging element adds the pixel signals from photosensors FS1, corresponding to a first field 104, and the pixel signals from the photosensors FS2 corresponding to a second field 105, in the vertical transmission CCD 41. The added two-line pixel signals 103 are horizontally transmitted and output by a horizontal transmission CCD (not shown). As a result, in both the first field time and the second field time, all of the pixel signals which were imaged by the solid state imaging element can be transmitted and output in one field time. But despite being able to be transmitted and output in one field time, a problem arises in that the imaging element can only read out the photosensors corresponding to either the first field 104 or the second field 105, rather than the combined pixel signals formed by the photosensors from both the first and second field.

Since the structure of a conventional solid state imaging element that separately reads out pixel signals in two field times differs from the structure of a conventional solid state imaging element that reads out pixel signals in one field time, such solid state imaging elements cannot be interchanged. This lack of interchangeability requires the use of more than one solid state imaging element and makes the imaging element inefficient.

### SUMMARY OF THE INVENTION

It is therefore an object of the present invention to provide a single solid state imaging element unit which can be interchangeably used to read out pixels in either two field times, or to read out pixel signals in one field time.

It is a further object of the present invention to provide a single solid state imaging element camera which can output signals of pixel data separately in two field times at the same time that it outputs signals of data of pixel signals in one field time.

It is a further object of the present invention to provide a single solid state imaging element camera in which a control state can be monitored while performing high speed position control.

It is still a further object of the present invention to provide a single solid state imaging element camera in which picture signals are simultaneously obtained at high speed with high resolution picture data.

Objects of the invention are achieved by a solid state imaging element camera equipped with an imaging element that images imaging light from a subject by pixel groups arrayed two-dimensionally in rows and columns. The imaging element obtains a pixel signal group from rows sequentially transmitted to a first horizontal transmission register, and from the first horizontal transmission register to a second register. An adding circuit adds two fields of picture signals that are output by the first and second horizontal transmission registers along respective parallel picture output terminals. A signal processing circuit performs predetermined signal processing on the added picture signals and outputs the processed added signals.

Further objects and advantages of the invention are achieved by a solid state imaging unit having an imaging element that images imaging light from a subject using pixel groups arrayed two-dimensionally in rows and columns. A picture signal group is obtained by the imaging element from rows that are sequentially transmitted to a first horizontal transmission register, and then transmitted from the first horizontal transmission register to a second transmission register. The first horizontal transmission register has a first picture output terminal that outputs a first field of picture signals, and the second horizontal transmission register has a second picture output terminal, positioned in a parallel relation to the first output terminal, that outputs a second field of picture signals. An adding circuit adds the first and second field of picture signals, and a first signal processing circuit performs predetermined signal processing on the added picture signals. A second signal processing circuit performs predetermined signal processing either exclusively on the first field of picture signals that were output at the first picture output terminal, or exclusively on the second field of picture signals output at the second picture output terminal. In this way, picture signals output from the first signal processing circuit can be used in position detection of an article to be controlled, while picture signals output from the second signal processing circuit can be used in the display of photographic pictures.

### BRIEF DESCRIPTION OF THE DRAWINGS

These and other objects and advantages of the invention will become apparent and more readily appreciated from the following description of the preferred embodiments, taken in conjunction with the accompanying drawings of which:

FIG. 1 is a schematic view of a solid state imaging element camera according a preferred embodiment of the present invention.

FIGS. 2A and 2B are schematic views of the transmission of electric charge in the solid state imaging element camera of FIG. 1.

FIGS. 3A, 3B and 3C are graphs illustrating the timing of an output state of picture signals in the solid state imaging element camera of FIG. 1.

FIGS. 4A (prior art) and 4B (prior art) are schematic views of a transmission operation of a conventional solid state imaging element which transmits and outputs all pixel signals in one field time.

FIGS. 5A (prior art) and 5B (prior art) are schematic views of a transmission operation of a conventional solid state imaging element which transmits and outputs pixel signals in two field times.

### DETAILED DESCRIPTION OF THE PREFERRED EMBODIMENTS

Reference will now be made in detail to the preferred embodiments of the present invention, examples of which are illustrated in the accompanying drawings, wherein like reference numerals refer to like elements throughout.

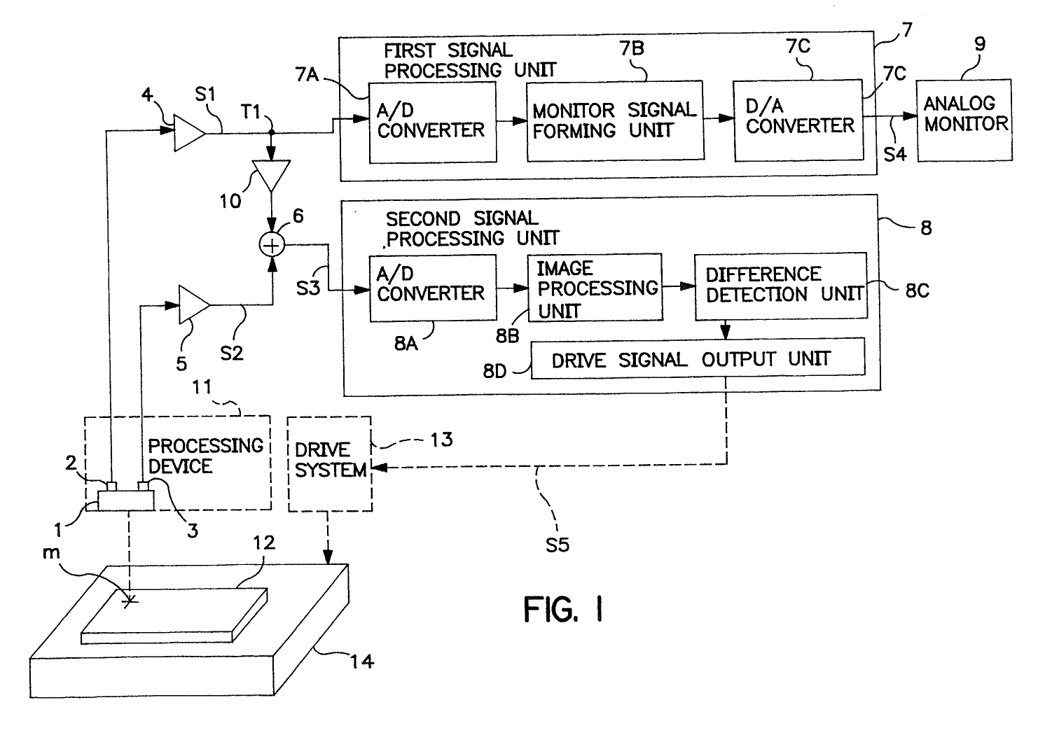

A preferred embodiment of a solid state imaging element camera according to the present invention is illustrated in FIG. 1. A processing device 11 uses a CCD imaging element 1 to process an image. CCD imaging element 1 images a neighborhood of a mark “m” on a treatment subject, such as a wafer 12 or the like, located on a movable two-dimensional table 14. Imaged picture signals are output from a first output terminal 2 and a second output terminal 3 of CCD imaging element 1. Picture signals are output from first output terminal 2, amplified by a buffer amplifier 4 and input to a first signal processing unit 7 as a first picture signal S1. First picture signal S1 is input to a connection point T1 by a buffer amplifier 10, and the signal amplified by the buffer amplifier 10 is input to an adder 6. The picture signal output from second output terminal 3 is amplified by a buffer amplifier 5 and input to the adder 6 as a second picture signal S2.

Adder 6 adds first picture signal S1 input from buffer amplifiers 4, 10 and the second picture signal S2 input from buffer amplifier 5, and the added signal S3 is input to a second signal processing unit 8.

First signal processing unit 7 has an A/D converter 7A, a monitor signal forming unit 7B, and a D/A converter 7C. A/D converter 7A inputs the first picture signal S1 from connection point T1 and converts it from an analog to a digital signal. Monitor signal forming unit 7B, based on the converted digital signal, forms a digital monitor signal suitable for an analog monitor 9. D/A converter 7C converts the digital monitor signal to an analog monitor signal S4, and outputs the signal S4 at a predetermined timing to an analog monitor 9.

Second signal processing unit 8 has an A/D converter 8A, an image processing unit 8B, a difference detection unit 8C, and a drive signal output unit 8D. A/D converter 8A converts added signal S3 from an analog to a digital pixel signal on which the image processing unit 8B then performs predetermined image processing. Difference detection unit 8C performs match processing on the processed image signal using a predetermined pattern, for example, the image signal of a “+” pattern, and detects as differences the positional displacements of CCD imaging element 1 and a mark “m” on the process subject 12. Drive signal output unit 8D outputs to a drive system 13, as a control signal, a feedback drive signal S5 which makes the detected difference zero. Drive system 13, based on input drive signal S5, then performs two-dimensional movement of the table 14.

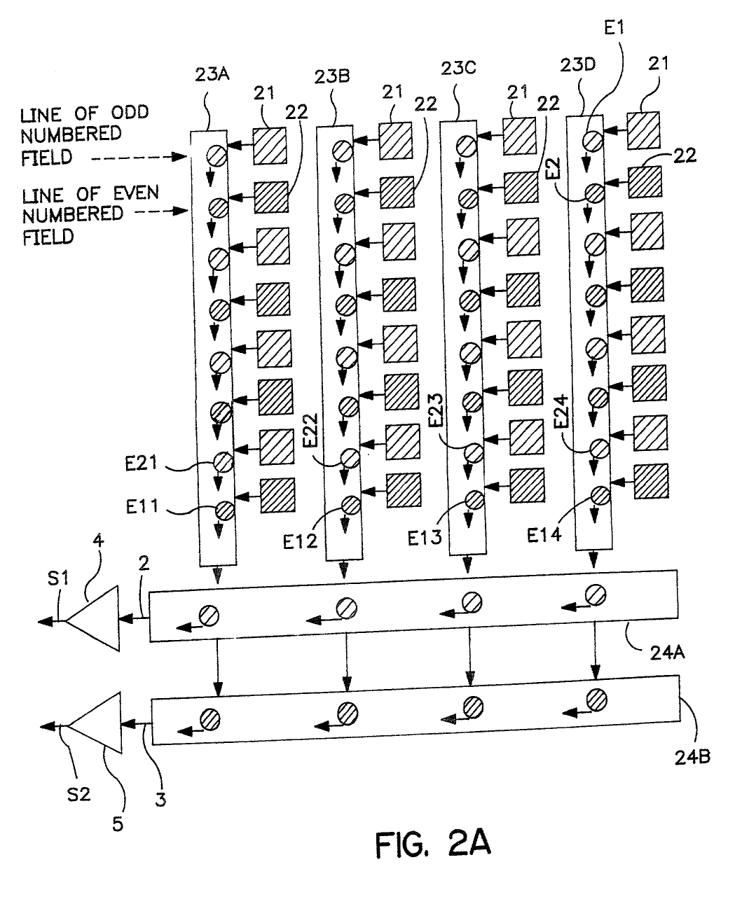

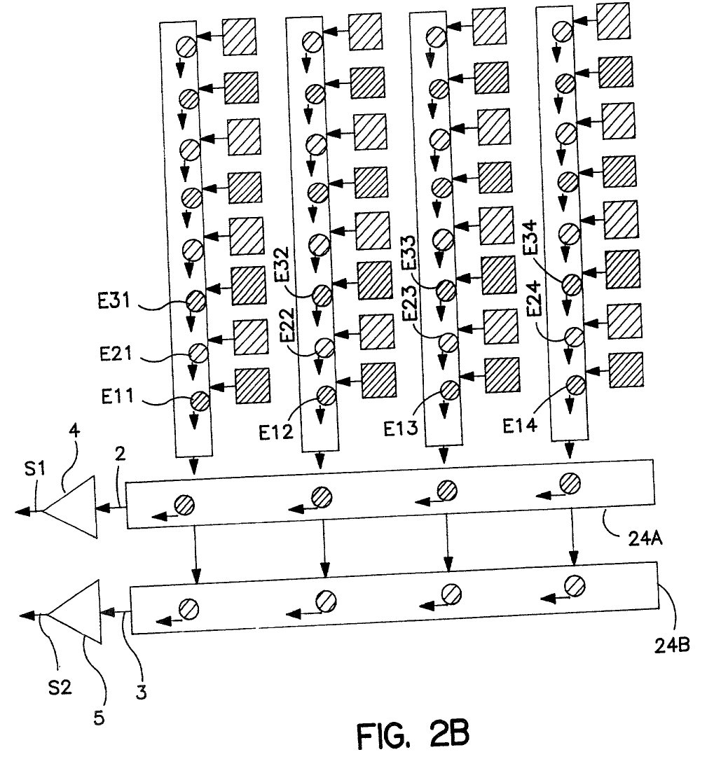

The transmission process of the CCD imaging element 1 corresponding to odd numbered lines is shown in FIG. 2A. A plurality of photosensors, including the photosensors 21, 22 shown by squares, after receiving imaging light over a predetermined time, simultaneously output resulting corresponding stored electrical charge to vertical transmission CCDs 23A-23D. The odd numbered photosensors include a row of photosensors 21 having spaced hash marks, as shown in FIG. 2A, while the even numbered photosensors include a row of photosensors 22 having closely spaced hash marks, as shown in FIG. 2A. A pixel signal El is the stored charge of an odd numbered field output from photosensor 21 and a pixel signal E2 is the stored charge of an even numbered field output from photosensor 22. Accordingly, photosensors 21, 22 and pixel signals E1, E2 output from the photosensors 21, 22 are alternately present as lines of odd numbered fields and lines of even numbered fields.

Pixel signals output to vertical transmission CCDs 23A-23D are transmitted vertically and output to horizontal transmission CCDs 24A, 24B. In the transmission state in an odd numbered field time, shown in FIG. 2A, a pixel signal corresponding to an odd numbered field is vertically transmitted and input to horizontal transmission CCD 24A where it is horizontally transmitted and output at high speed. A pixel signal corresponding to an even numbered field is vertically transmitted from horizontal CCD 24A and input to horizontal CCD 24B where it is horizontally transmitted and output at high speed.

Horizontal transmission CCD 24A and 24B perform horizontal transmission when the vertical transmission of two line portions has been performed. For example, during the initial vertical transmission, one line of pixel group E11-E14 is simultaneously vertically transmitted and input to horizontal transmission CCD 24A. At the same time, pixel signal group E21-E24 is transmitted to the line of previously vertically transmitted pixel signal group E11-E14. No horizontal transmission is performed at this initial state. Pixel signal group E11-E14 is vertically transmitted to a further line, from horizontal transmission CCD 24A to horizontal transmission CCD 24B simultaneously with the next vertical transmission. At the same time, pixel signal group E21-E24 is also vertically transmitted to horizontal transmission CCD 24A. Then, pixel signal group E21-E24, which is within horizontal transmission CCD 24A, and pixel signal group E21-E24 which is within horizontal transmission CCD 24B, are simultaneously transmitted horizontally. After this horizontal transmission, the pixel signal group of the third line vertical transmission sequence is transmitted to horizontal transmission CCD 24B, and the pixel signal group of the fourth line vertical transmission sequence is transmitted to horizontal transmission CCD 24A. Proceeding in this manner, two line horizontal transmission is performed at about the end of the vertical transmission of two line portions. Then, at the point in time when horizontal transmission of all pixel signals has ended, transmission processing corresponding to odd numbered field(s) ends.

Pixel signals output from horizontal transmission CCD 24A are amplified by buffer amplifier 4 and output as first picture signal S1. Pixel signals output from horizontal transmission CCD 24B are amplified by buffer amplifier 5 and output as second picture signal S2.

In the transmission processing corresponding to even numbered lines, which is performed after the transmission processing corresponding to odd numbered fields shown in FIG. 2A, pixel signals of even numbered fields are transmitted and output from horizontal transmission CCD 24A, and pixel signals of odd numbered fields are transmitted and output from horizontal transmission CCD 24B. Accordingly, in FIG. 2B, pixel groups transmitted by horizontal transmission CCDs 24A and 24B, shown in FIG. 2A, become replaced.

In the vertical transmission sequence for pixel signal group E11-E14, shown in FIG. 2B, one line is vertically transmitted and input to horizontal transmission CCD 24A simultaneously with the initial vertical transmission. After this vertical transmission, pixel signal group E11-E14 is horizontally transmitted. In the vertical transmission sequence for the second line, pixel signal group E21-E24, and the third line, pixel signal group E31-E34, the two lines are serially vertically transmitted to respective horizontal transmission CCDs 24B and 24A, simultaneously with vertical transmission of the next two line portions. Transmitted pixel signal group E21-24 and E31-34 is then horizontally transmitted. The transmission processes shown in FIG. 2A and 2B thereafter become alternately repeated for the transmission of all pixel signals.

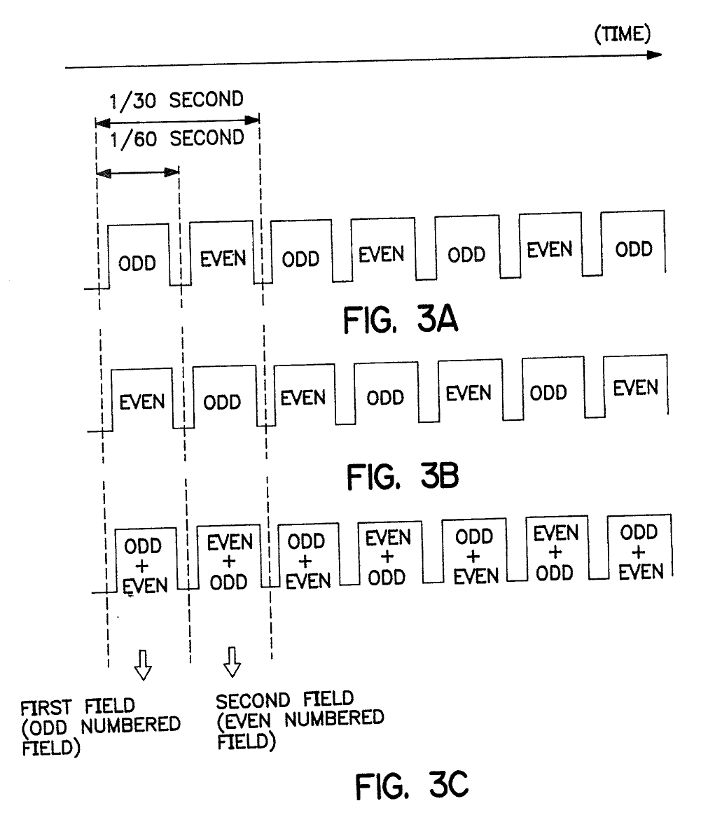

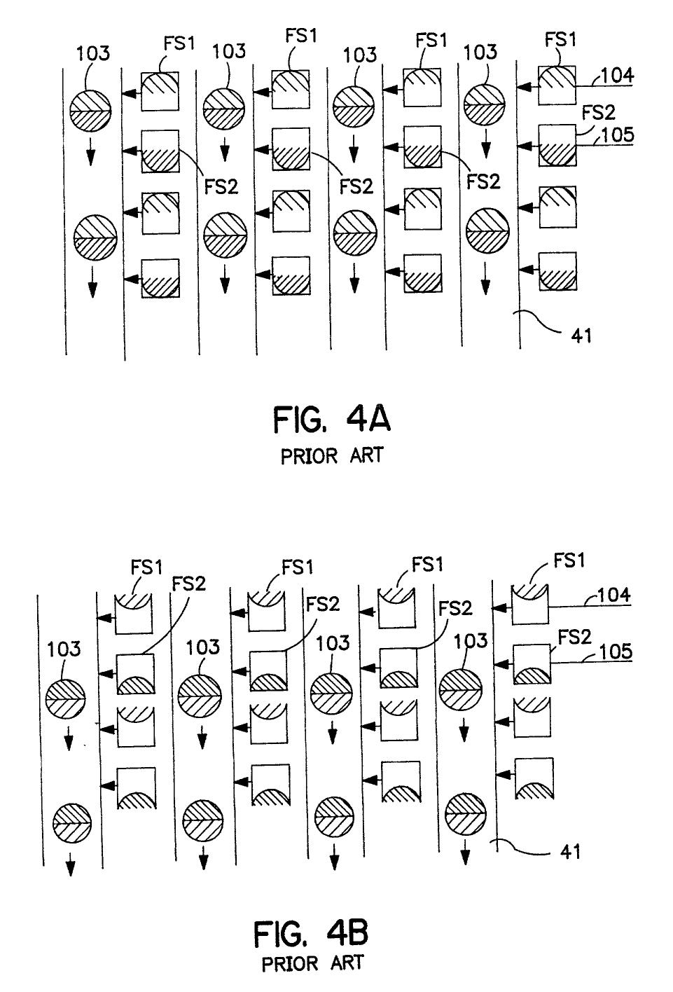

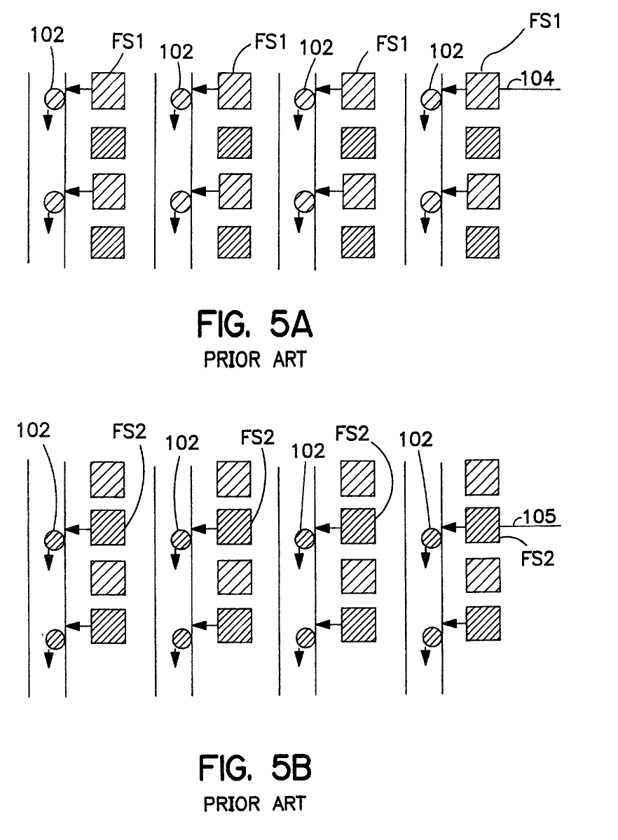

An output time chart of first picture signal S1, second picture signal S2, and additive signal S3, output from CCD imaging element 1, is shown in FIGS. 3A-3C. First picture signal S1 includes odd numbered fields and even numbered fields alternately output from horizontal transmission CCD 24A, as shown in FIG. 3A. Second picture signal S2 includes even numbered fields and odd numbered fields which are alternately output from horizontal transmission CCD 24B, as shown in FIG. 3B. When first picture signal S1 is a pixel signal of an odd numbered field, second picture signal S2 is a pixel signal of an even numbered field, and when first picture signal S1 is a pixel signal of an even numbered field, second picture signal S2 is a pixel signal of an odd numbered field.

Additive signal S3 is obtained with every field time by adding the first picture signal and the second picture signal, as shown in FIG. 3C, by adder 6.

Processing a first picture signal S1 using first signal processing unit 7 and generating a signal processed monitor signal using analog monitor 9, in addition to having one frame time as 1/30 second and each field time as 1/60 second of odd numbered and even numbered fields which constitute one frame, results in an interlaced method of image output. The pixels of analog monitor 9 correspond to each photosensor of the CCD imaging element(s), and normal resolving power is obtained with each pixel of each photosensor made independent.

Since signal processing is possible in one field time, and second picture signal S2 input in second signal processing unit 8 is a signal which corresponds to the data of all the pixel signals in each field, high speed processing becomes possible.

Although first signal processing unit 7 and second signal processing unit 8 are both used in order to generate the drive signal S5, first signal processing unit 7 and analog monitor 9 could be eliminated without affecting the performance of the position control.

By having two picture output terminals available prior to the processing of the signals, picture signals that include the data of all pixels can be output at high speed, without changing the solid state imaging element itself, so that the imaging element can easily be used to perform high speed position control. In addition, by being able to process the signal from the output of one of the two picture output terminals of the imaging element, high resolution picture signals can be obtained, making it possible to obtain picture signals output at high speed simultaneously with picture signals having high resolution so that the control state of the subject can be monitored at high resolution. Using only one CCD imaging element 1, position matching of the processing subject 12 on table 14 can be performed at high speed, with respect to the absolute position of the processing device 11 containing the imaging element 1, and the picture which CCD imaging element 1 has imaged can be monitored at high resolution.

Although a few preferred embodiments of the present invention have been shown and described, it will be appreciated by those skilled in the art that changes may be made in these embodiments without departing from the principles and spirit of the invention, the scope of which is defined in the claims and their equivalents. For example, although a preferred embodiment of the invention has been described in the context of a camera, the invention is not so limited and a solid state imaging unit can be used in other applications.

What is claimed is:

1. A solid state imaging camera, comprising:
an imaging element to image light from a subject using pixels arrayed two-dimensionally in rows and columns, wherein a first pixel signal field is obtained by sequentially transmitting rows of horizontally arrayed pixels to a first horizontal transmission register, and from the first horizontal transmission register to a second horizontal transmission register, the first horizontal transmission register having a first picture output terminal and the second horizontal transmission register having a second picture output terminal, positioned parallel to the first picture output terminal, such that the first and second picture output terminals output two fields of picture signals;
an adding circuit to add picture signals output from the first and second output terminals; and
a signal processing circuit to perform predetermined signal processing on the added picture signals and to output the processed added signals.

2. The solid state imaging camera according to claim 1, wherein the picture signal output from the adding circuit is read out as a signal that contains the data of the pixels in one field time.

3. The solid state imaging camera according to claim 1, wherein said signal processing circuit comprises:
an analog to digital converter to convert the added picture signals to a digital pixel signal;
an image processing unit to perform predetermined image processing on the digital pixel signal to produce a processed image signal;
a difference detection unit to perform match processing on the processed image signal, using a predetermined pattern, to detect positional displacement of said imaging element;
a drive signal output unit to output a feedback control drive signal for making the detected positional displacement of the image signal approximately equal to zero; and
a drive system to perform two-dimensional movement of the subject based on the feedback control drive signal.

4. A solid state imaging camera, comprising:
an imaging element to image light from a subject using pixels arrayed two-dimensionally in rows and columns, wherein a first picture signal field is obtained by sequentially transmitting rows of horizontally arrayed pixels to a first horizontal transmission register, and from the first transmission register to a second horizontal transmission register;
a first horizontal transmission register output terminal to output a first picture signal;
a second horizontal transmission register output terminal, parallel to the first horizontal transmission register output terminal, to output a second picture signal;
an adding circuit to add the first and second picture signals;
a first signal processing circuit to perform predetermined signal processing on the added first and second picture signals; and
a second signal processing circuit to perform predetermined signal processing on one of said first and second output picture signals.

5. The solid state imaging camera according to claim 4, in which the second signal processing circuit comprises:
an analog to digital converter to convert the first picture signal to a digital signal;
an analog monitor;
a monitor signal forming unit to form a digital monitor signal, based on the converted digital signal, for the analog monitor; and
a digital to analog converter to convert the digital monitor signal to an analog monitor signal, wherein the digital to analog convertor outputs the analog monitor signal at a predetermined timing to the analog monitor.

6. The solid state imaging camera according to claim 4, in which the first signal processing circuit comprises:
an analog to digital converter to convert the added picture signals to a digital pixel signal;
an image processing unit to perform predetermined image processing on the digital pixel signal;
a difference detection unit to perform match processing on the processed image signal, using a predetermined pattern, to detect positional displacement of said imaging element;
a drive signal output unit to output a feedback control drive signal that makes the positional displacement of the subject approximately equal to zero; and
a drive system to perform two-dimensional movement of the subject based on the feedback control drive signal.

7. The solid state imaging camera according to claim 4, wherein the picture signal output from the adding circuit is read out as a signal which contains the data of all the pixels in one field time.

8. The solid state imaging camera according to claim 4, wherein the first and second picture signals are output alternately from the second signal processing circuit, such that the signals of all the pixels are output in two fields.

9. The solid state imaging camera according to claim 4, wherein picture signals output from the first signal processing circuit are used to detect the position of the subject, and wherein picture signals output from the second signal processing circuit are used to display an image of the subject.

10. The solid state imaging camera according to claim 4, wherein the first picture signal is a pixel signal of an odd numbered field when the second picture signal is a pixel signal of an even numbered field.

11. The solid state imaging camera according to claim 4, wherein the first picture signal is a pixel signal of an even numbered field when the second picture signal is a pixel signal of an odd numbered field.

12. The solid state imaging camera according to claim 4, wherein one frame time is 1/30 of a second and each field time is 1/60 of a second of the odd numbered and even numbered fields which constitute one frame.

13. A solid state imaging unit comprising:
an imaging element to image light from a subject using pixels arrayed two-dimensionally in rows and columns;
a first horizontal transmission register, having a first output terminal, to sequentially receive rows of horizontally arrayed pixels from the two-dimensional array and output a first signal;
a second horizontal transmission register, having a second output terminal parallel to the first output terminal, to sequentially receive rows of horizontally arrayed pixels from the two-dimensional array and output a second picture signal;
an adding circuit to add picture signals;
a first signal processing unit to perform predetermined signal processing on the added picture signals; and
a second signal processing unit to perform predetermined signal processing on one of the picture signals.

14. The solid state imaging camera according to claim 13, wherein a picture signal output by the adding circuit is read out as a signal that contains of all pixels imaged by the imaging element in one field time.

15. The solid state imaging camera according to claim 13, wherein the first picture output terminal outputs a first field of picture signals and the second picture output terminal outputs a second field of picture signals, and wherein the picture signals from the first field and the picture signals from the second field are output alternately from the second signal processing circuit, such that the signals of all the pixels are output in two fields.

16. The solid state imaging camera according to claim 13, wherein the picture signals output from the first signal processing unit are used to detect the position of the subject, and wherein the picture signals output from the second signal processing unit are used to display an image of the subject.

17. The solid state imaging camera according to claim 13, wherein the first picture signal is a pixel signal of an odd numbered field when the second picture signal is a pixel signal of an even numbered field.

18. The solid state imaging camera according to claim 13, wherein the first picture signal is a pixel signal of an even numbered field when the second picture signal is a pixel signal of an odd numbered field.

19. The solid state imaging camera according to claim 13, in which a frame time is 1/30 of a second and a field time is 1/60 of a second of odd numbered and even numbered fields which constitute a frame.

20. A solid state imaging unit, comprising:
an imaging element to image light from a subject using pixels arrayed two-dimensionally in rows and columns, wherein a first pixel signal field is obtained by sequentially transmitting rows of horizontally arrayed pixels to a first horizontal transmission register, and from the first horizontal transmission register to a second horizontal transmission register, the first horizontal transmission register having a first picture output terminal and the second horizontal transmission register having a second picture output terminal, positioned parallel to the first picture output terminal, such that the first and second picture output terminals output two fields of picture signals;
an adding circuit to add picture signals output from the first and second output terminals;
an analog to digital converter to convert the added picture signals to a digital pixel signal;
an image processing unit to perform predetermined image processing on the digital pixel signal to produce a processed image signal;
a difference detection unit to perform match processing on the processed image signal, using a predetermined pattern, to detect positional displacement of said imaging element;
a drive signal output unit to output a feedback control drive signal to make the detected positional displacement of the image signal approximately equal to zero; and
a drive system to perform two-dimensional movement of the subject based on the feedback control drive signal.

21. A solid state imaging camera, comprising:
means for imaging light from a subject using two-dimensionally arrayed pixels horizontally transmitted sequentially and outputting two fields of picture signals;
means for adding the output picture signals; and
means for performing predetermined signal processing on the added picture signals and generating a processed added signal output.
